(19) United States
(12) Patent Application Publication
(10) Pub. No.: US 2016/0319744 A1
(43) Pub. Date: Nov. 3, 2016

(54) 2-STAGE SLOPES THRUST BEARING PAD DESIGN AT MIST LUBRICATION CONDITION

(71) Applicant: GM GLOBAL TECHNOLOGY OPERATIONS LLC, Detroit, MI (US)

(72) Inventors: Dingfeng DENG, Auburn Hills, MI (US); Fanghui SHI, Bloomfield Hills, MI (US); Ran WU, Auburn Hills, MI (US)

(21) Appl. No.: 14/700,674

(22) Filed: Apr. 30, 2015

(51) Int. Cl. F02C 7/06; F02C 7/36; F02C 6/12

(52) U.S. Cl. CPC F02C 7/06; F02C 6/12; F02C 7/36; F05D 2220/40; F05D 2240/50; F05D 2240/60

(57) ABSTRACT

A turbocharger is provided including a turbine wheel and a compressor wheel attached to one another by a shaft. A thrust plate includes a plate body having an aperture there through and defining a plurality of circumferentially spaced pad regions that define a land region that is perpendicular to a rotational axis of the shaft. The plate body further defines a plurality of two stage slope regions adjacent to each of the land regions. The two stage slope regions include a steep slope portion and a gradual slope portion disposed between the steep slope portion and the land regions. The rotary assembly of the turbocharger including a thrust surface that engages the pad regions. The two-stage slope regions provide improved loading capacity by the combination of better lubricant oil availability due to the steep slope region and optimized tribological performance due to the gradual slope region.

### FIELD

The present disclosure relates to a turbocharged internal combustion engine and more particularly to an improved thrust bearing design for improved lubrication.

### BACKGROUND

This section provides background information related to the present disclosure which is not necessarily prior art.

Internal combustion engines are used to generate considerable levels of power for prolonged periods of time on a dependable basis. Many such engine assemblies employ a supercharging device, such as an exhaust gas turbine driven turbocharger, to compress the airflow before it enters the intake manifold of the engine in order to increase power and efficiency.

Specifically, a turbocharger utilizes a centrifugal gas compressor that forces more air and, thus, more oxygen into the combustion chambers of the engine than is otherwise achievable with ambient atmospheric pressure. The additional mass of oxygen-containing air that is forced into the engine improves the engine's volumetric efficiency, allowing it to burn more fuel in a given cycle, and thereby produce more power.

A typical turbocharger employs a central shaft that is supported by one or more bearings and transmits rotational motion between an exhaust-driven turbine wheel and an air compressor wheel. Both the turbine and compressor wheels are fixed to the shaft, which in combination with various bearing components constitute the turbocharger's rotating assembly. It is important to maintain lubrication of the turbocharger thrust bearing. Test results show that low lubrication flow upstream and high flow at the outlet due to large centrifugal force at high speed cause a mist lubrication condition in the thrust bearing cavity. The mist lubrication condition in the bearing cavity in current thrust plate designs can starve the thrust pads and reduce the thrust bearing's load capacity.

### SUMMARY

This section provides a general summary of the disclosure, and is not a comprehensive disclosure of its full scope or all of its features.

A turbocharger is provided including a turbine wheel and a compressor wheel attached to one another by a shaft. A thrust plate includes a plate body having an aperture there through and defining a plurality of circumferentially spaced pad regions that define a land region that is perpendicular to a rotational axis of the shaft. The pad regions further define a plurality of two-stage slope regions adjacent to each of the land regions. The two stage slope regions include a steep slope portion and a gradual slope portion disposed between the steep slope portion and the land regions. The rotary assembly of the turbocharger includes a thrust surface that engages the land regions. The two-stage slope regions provide improved loading capacity by the combination of better lubricant oil availability due to the steep slope region and optimized tribological performance due to the gradual slope region.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of an engine assembly according to the present disclosure;

FIG. 2 is a schematic cross-sectional illustration of the turbocharger shown in FIG. 1;

FIG. 3 is a plan view of the thrust pad regions of the improved thrust plate according to the principles of the present disclosure; and

FIGS. 4a-4c are cross-sectional views taken along line 4-4 of FIG. 3 of the pad regions having alternative 2-stage slope designs.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

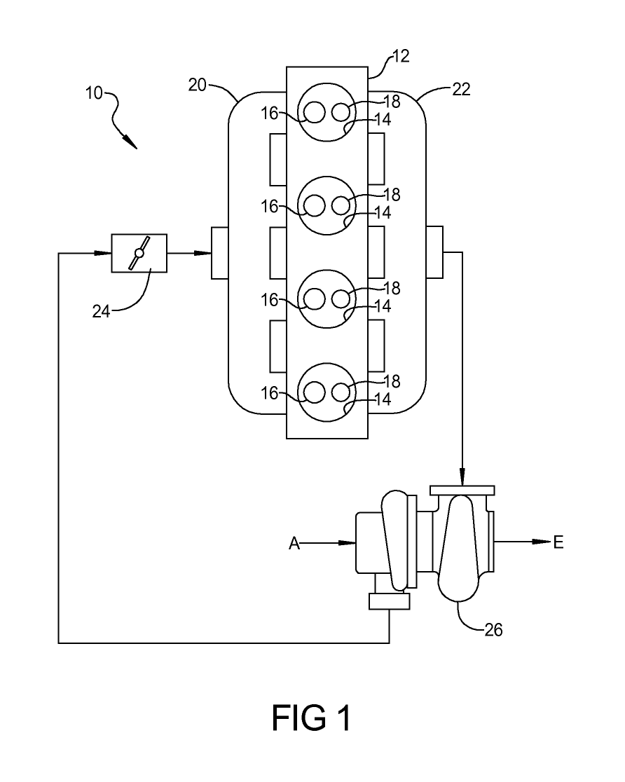

An engine assembly 10 is illustrated in FIG. 1 and may include an engine structure 12 defining a plurality of cylinders 14 and intake and exhaust ports 16, 18 in communication with the cylinders 14. An intake manifold 20 is in communication with the intake ports and an exhaust manifold 22 is in communication with the exhaust ports 18. A throttle valve 24 and a turbocharger 26 are provided in an intake passage that is connected to the intake manifold 20 and the turbocharger 26 is also in communication with an exhaust passage connected to the exhaust manifold 22. The engine assembly 10 is illustrated as an in-line four cylinder arrangement for simplicity. However, it is understood that the present teachings apply to any number of piston-cylinder arrangements and a variety of reciprocating engine configurations including, but not limited to, V-engines, inline engines, and horizontally opposed engines, as well as both overhead cam and cam-in-block configurations.

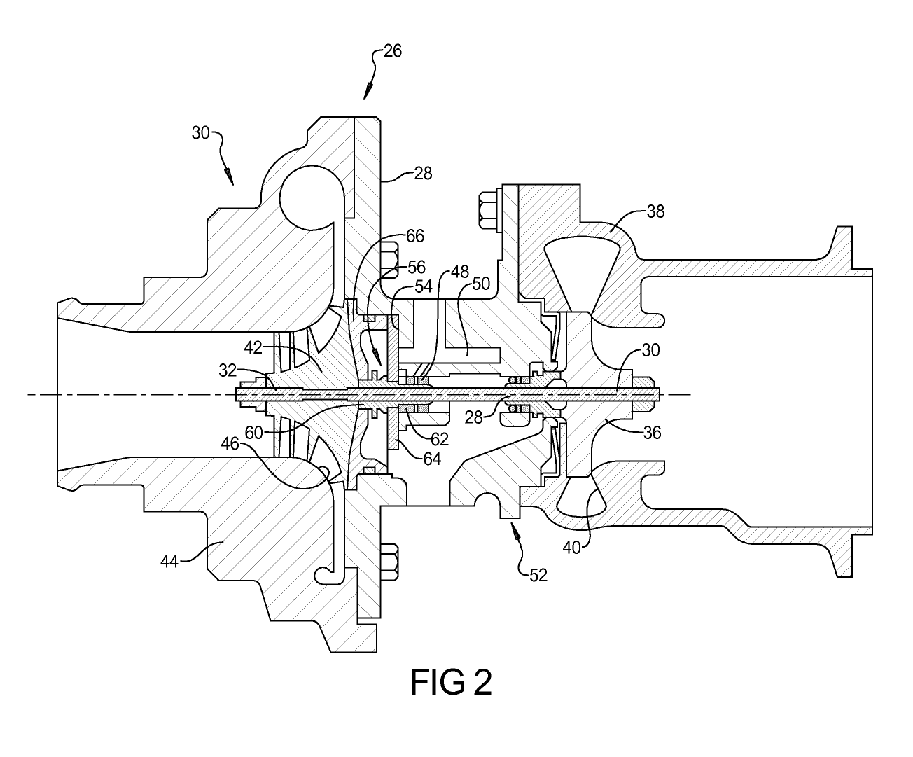

As shown in FIG. 2, the turbocharger 26 includes a shaft 28 having a first end 30 and a second end 32. A turbine wheel 36 is mounted on the shaft 28 proximate to the first end 30 and configured to be rotated by combustion exhaust gasses emitted from the cylinders 14. The turbine wheel 36 is typically formed from a temperature and oxidation resistant material, such as a nickel-chromium-based “inconel” super-alloy to reliably withstand temperatures of the combustion exhaust gasses which in some engines may approach 2,000 degrees Fahrenheit. The turbine wheel 36 is disposed inside a turbine housing 38 that includes a volute or scroll 40. The scroll 40 receives the combustion exhaust gases and directs the exhaust gases to the turbine wheel 36.

As further shown in FIG. 2, the turbocharger 26 also includes a compressor wheel 42 mounted on the shaft 28 proximate to the second end 32. The compressor wheel 42 is configured to pressurize the airflow being received from the ambient for eventual delivery to the cylinders 14. The compressor wheel 42 is disposed inside a compressor cover 44 that includes a volute or scroll 46. The scroll 46 receives the airflow and directs the airflow to the compressor wheel 42. Accordingly, rotation is imparted to the shaft 28 by the combustion exhaust gases energizing the turbine wheel 36, and is in turn communicated to the compressor wheel 42.

With continued reference to FIG. 2, the shaft 28 is supported for rotation via a journal bearing 48. The journal bearing 48 is mounted in a bore 50 of a bearing housing 52 and is lubricated and cooled by a supply of pressurized engine oil. The bearing housing 52 includes a thrust wall 54. The journal bearing 48 is configured to control radial motion and vibrations of the shaft 28.

As shown in FIG. 2, the turbocharger 26 also includes a thrust bearing assembly 56. The thrust bearing assembly 56 includes a thrust collar 60 and a thrust washer 62. The turbocharger 26 also includes a thrust plate 64 that is held in place by a thrust retainer 66 against the bearing wall 54.

The thrust bearing assembly 56 counteracts the net thrust force developed within the turbocharger 26, when such a force is acting towards the compressor wheel 42. As shown, the thrust bearing assembly 56 is positioned on the shaft 28, between the journal bearing 48 and the compressor wheel 42. The bearing assembly 56 is lubricated and cooled by the supply of pressurized engine oil supplied via a pump (not shown). During operation of the turbocharger 26, i.e., when the turbine wheel 36 is energized by the combustion exhaust gases, the thrust washer 62 transmits thrust forces developed by the turbine wheel to the thrust plate 64. Although the thrust washer 62 is shown, it should be understood that alternative thrust surfaces can be otherwise formed on the shaft 28 such as an integrally formed or separately formed shoulder.

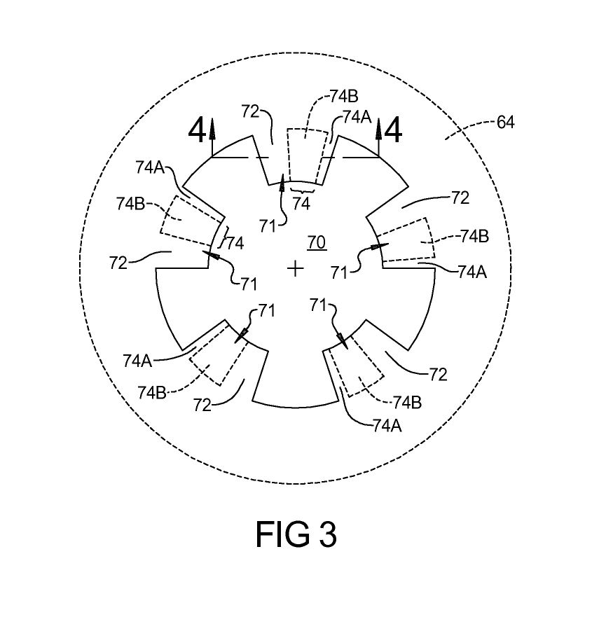

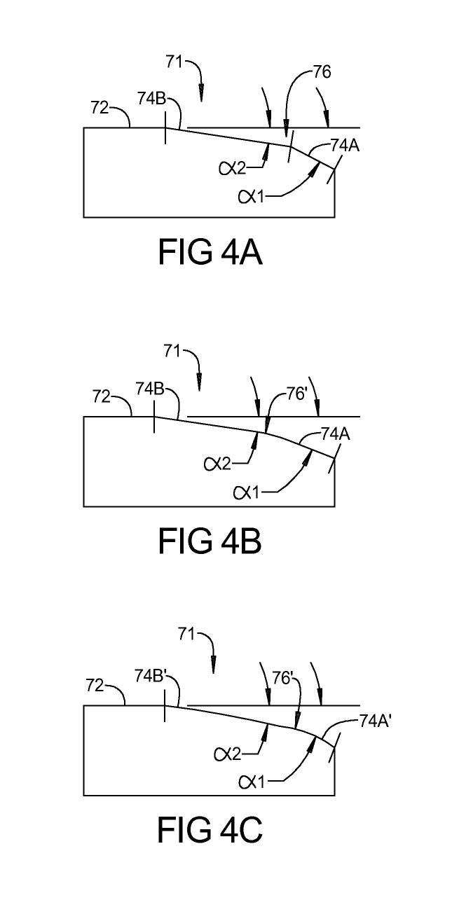

With reference to FIG. 3, the thrust plate 64 is shown including an aperture 70 extending therethrough for receiving the shaft 28 and a plurality of circumferentially spaced pad regions 71 that are engaged by the thrust washer or other thrust surface on the shaft 28. The pad regions 71 each include a land region 72 that is generally perpendicular to the rotational axis of the shaft 28. A plurality of two-stage slope regions 74 are adjacent to each of the land regions 72. The two-stage slope regions 74 include a steep slope portion 74A and a gradual slope portion 74B disposed between the steep slope portion 74A and the land region 72. FIG. 4a shows a cross sectional view of a pad region 71 and a two-stage slope region of the a thrust plate according to the principles of the present disclosure. In FIG. 4a, the steep slope region 74A and the gradual slope region 74B are shown as two generally planar surfaces with the steep slope region provided at a relatively larger angle α1 relative to the land region 72 than the angle α2 of the gradual slope region 74B. As shown in FIG. 4a, the transition 76 between the steep slope region 74A and the gradual slope region 74B can be angled, or alternatively, as shown in FIG. 4b, the transition 76′ can be arcuate or curved. As a further alternative, as shown in FIG. 4c, the steep slope region 74A′ and/or the gradual slope region 74B′ can be a convex arcuate surface where a tangent to the arcuate steep slope region 74A′ is at a relatively larger angle α1′ relative to the pad region than an angle α2′ of a tangent to the arcuate gradual slope region 74B′.

The land regions 72 and two-stage slope regions 74 are designed so that the steep slope region 74A provides a larger area to take more lubricant oil from the cavity, which is particularly favorable when the cavity is at mist lubrication condition. Meanwhile, the bearing loading capacity is still optimized by the gradual slope region 74B. The loading capacity is improved significantly by the combination of better lubricant oil availability due to the steep slope region 74A and optimized tribological performance due to the gradual slope region 74B.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A turbocharger, comprising:
a housing;
a rotary assembly including a turbine and a compressor attached to one another by a shaft, said rotary assembly including a thrust surface;
a thrust plate disposed in the housing for opposing the thrust surface of the rotary assembly, said thrust plate having an aperture there through for receiving the shaft and defining a plurality of circumferentially spaced pad regions that define a land region that is perpendicular to a rotational axis of the shaft, the pad regions further defining a plurality of two stage slope regions adjacent to each of the land regions, the two stage slope regions including a steep slope region and a gradual slope region disposed between the steep slope region and the land regions.

2. The turbocharger according to claim 1, wherein said steep slope region and said gradual slope region are generally planar.

3. The turbocharger according to claim 1, wherein said steep slope region and said gradual slope region are arcuate.

4. The turbocharger according to claim 1, wherein at least one of said steep slope region and said gradual slope region are generally planar.

5. The turbocharger according to claim 1, wherein at least one of said steep slope region and said gradual slope region are arcuate.

6. The turbocharger according to claim 4, wherein a transition region between said steep slope region and said gradual slope region is angular.

7. The turbocharger according to claim 4, wherein a transition region between said steep slope region and said gradual slope region is arcuate.

8. The turbocharger according to claim 5, wherein a transition region between said steep slope region and said gradual slope region is angular.

9. The turbocharger according to claim 5, wherein a transition region between said steep slope region and said gradual slope region is arcuate.
